(19) United States
(12) Patent Application Publication
(10) Pub. No.: US 2026/0312311 A1
(43) Pub. Date: Oct. 8, 2026

(54) MODULAR JUMPER CABLE APPARATUS

(71) Applicant: Michael J. DeSanti, Hawley, PA (US)

(72) Inventor: Michael J. DeSanti, Hawley, PA (US)

(21) Appl. No.: 19/640,658

(22) Filed: Apr. 7, 2026

Related U.S. Application Data
(60) Provisional application No. 63/784,835, filed on Apr. 7, 2025.

(51) Int. Cl. H01R 11/24; H01R 13/64; H01R 24/22; H01R 24/30

(52) U.S. Cl. CPC H01R 11/24; H01R 13/64; H01R 24/22; H01R 24/30

(57) ABSTRACT

A modular jumper cable apparatus that includes a first cable segment having a first end provided with a first pair of battery clamps configured for connection to a discharged vehicle battery and a second end terminating in a female electrical outlet connector; and a second cable segment having a first end provided with a second pair of battery clamps configured for connection to a donor vehicle battery and a second end terminating in a male electrical plug connector. The male electrical plug connector of the second cable segment is configured to (i) directly mate with the female electrical outlet connector of the first cable segment to form a short-range jumper cable, and (ii) alternatively mate with female receptacle end of a standard electrical extension cord while a male plug end of the same extension cord mates with the female electrical outlet connector of the first cable segment, thereby forming an extended-length jumper cable of user-selectable length.

### RELATED APPLICATIONS

This application claims priority to U.S. Provisional Patent Application No. 63/784,835 filed Apr. 7, 2025, entitled “MODULAR JUMPER CABLE APPARATUS”, which is hereby incorporated by reference in its entirety.

### BACKGROUND OF THE INVENTION

The present invention relates to automotive jumper cables and the like.

Traditional automotive jumper cables are typically fixed-length, bulky, heavy, and difficult to store and transport. Their fixed length often proves insufficient in emergency roadside situations where vehicles cannot be positioned close enough for the cables to reach (e.g., in parking lots, ditches, or off-road locations). Users must either purchase multiple sets of cables or long, unwieldy cables that are impractical for everyday carry. There is a long-felt but unmet need for a jumper cable system that provides customizable length using commonly available household or industrial items while maintaining full electrical functionality, polarity identification, and compact storage.

### SUMMARY OF THE INVENTION

The present invention provides a modular jumper cable apparatus comprising two distinct, short cable halves that interface with any standard electrical extension cord (or directly with each other) to create a fully functional, extended automotive jumper cable of virtually any desired length. The system dramatically improves reach, portability, and convenience without requiring the user to purchase or carry long, dedicated jumper cables.

In one embodiment, a modular jumper cable apparatus is provide that includes a first cable segment having a first end provided with a first pair of battery clamps configured for connection to a discharged vehicle battery and a second end terminating in a female electrical outlet connector; and a second cable segment having a first end provided with a second pair of battery clamps configured for connection to a donor vehicle battery and a second end terminating in a male electrical plug connector, wherein the male electrical plug connector of the second cable segment is configured to (i) directly mate with the female electrical outlet connector of the first cable segment to form a short-range jumper cable, and (ii) alternatively mate with female receptacle end of a standard electrical extension cord while a male plug end of the same extension cord mates with the female electrical outlet connector of the first cable segment, thereby forming an extended-length jumper cable of user-selectable length.

In one embodiment, the female electrical outlet connector and the male electrical plug connector are standard three-prong household electrical connectors.

In one embodiment, the female first cable segment further comprises a visible identification tag labeled “LOW BAT” affixed proximate the female electrical outlet connector, and the second cable segment further comprises a visible identification tag labeled “GA BAT” affixed the male electrical plug connector.

In one embodiment, the first pair of battery clamps and the second pair of battery clamps are color-coded with red insulation on the positive conductor and black insulation on the negative conductor.

In one embodiment, the first and second cable segments comprise high-visibility orange insulated wire having a gauge sufficient to carry automotive jump-start currents.

In one embodiment, the apparatus is configured such that, when connected directly or via an extension cord, the red and black polarity of the battery clamps is preserved end-to-end.

In one embodiment, an apparatus comprises least one electrical extension cord packaged together with the first and second cable segments as a kit.

Additional aspects of the present invention will be apparent in view of the description which follows.

### BRIEF DESCRIPTION OF THE FIGURES

The invention may be more completely understood in consideration of the following detailed description of various embodiments of the invention in connection with the accompanying drawings, in which:

FIG. 1 is a perspective view of the fully assembled modular jumper cable apparatus connected to a standard coiled orange extension cord, showing the two cable halves bridging the distance between battery clamps.

FIG. 2 is a photograph of the two separate cable halves laid flat, illustrating the battery clamps, color-coded wires, female/male connectors, and blue identification tags (“LOW BAT” and “GA BAT”).

FIG. 3 is a photograph of the two cable halves connected directly (without an extension cord), forming a short-range jumper cable loop.

While the invention is amenable to various modifications and alternative forms, specifics thereof have been shown by way of example in the drawings and will be described in detail. It should be understood, however, that the intention is not to limit the invention to the particular embodiments described but rather to include all modifications, equivalents, and alternatives.

### DETAILED DESCRIPTION OF THE INVENTION

The modular jumper cable apparatus comprises two distinct cable halves designed to interface seamlessly with standard household or industrial electrical extension cords (e.g., 120V AC-rated 3-prong cords commonly found in homes, garages, or job sites), preferably an extension cord capable of handling current during jump starting of a vehicle, which may exceed 100 Amps, i.e., 4 AWG or better.

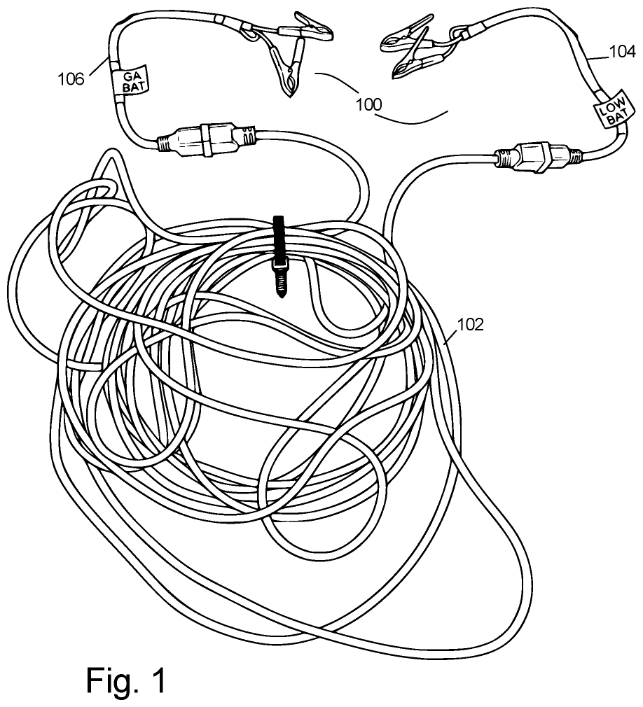

Referring to FIG. 1, the modular jumper cable 100 apparatus is shown in a fully assembled state, integrated with a standard electrical extension cord 102. The system consists of two distinct cable halves—a first half 104 and a second half 106—connected to the opposite ends of a coiled extension cord. As illustrated in FIG. 1, the modular components are designed to plug directly into the male and female ends of the extension cord, effectively utilizing the length of the cord to bridge the distance between two vehicles. This configuration transforms the two short halves plus the extension cord into a single, long, high-conductivity jumper cable whose length is limited only by the extension cord chosen by the user. The primary cable segments may be colored red/black to match standard high-visibility extension cords, and they feature blue identification tags near the terminal ends.

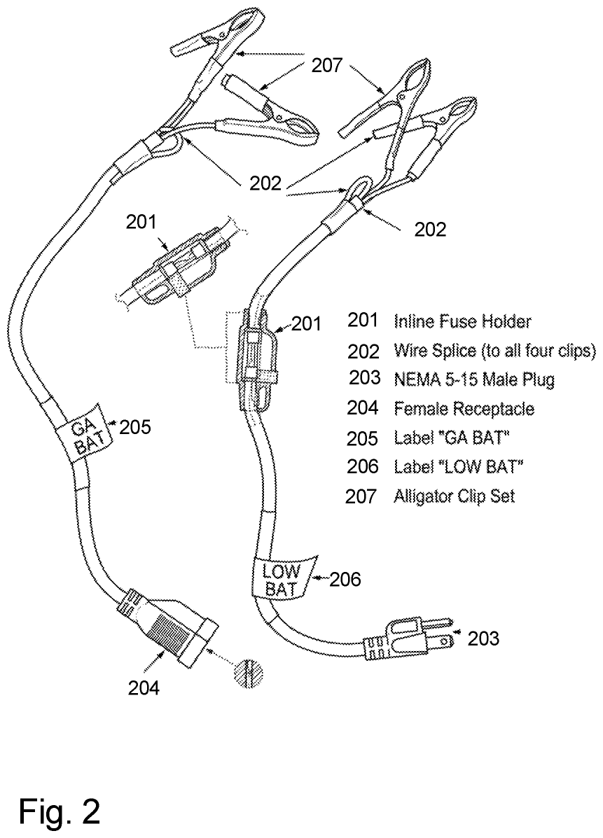

Turning to FIG. 2, the two distinct segments that comprise the modular system are shown in detail. The First Half 104 features a first end with battery clamps 207 for connecting to a vehicle's battery terminals (color-coded red and black to ensure proper polarity). The second end terminates in a female electrical outlet connector 204, such as a standard three-prong female plug, or more preferably a connector sufficient to handle typical jump starting operations, such as male/female 4-1 AWG welding cable connectors. This component may be marked with a tag labeled “LOW BAT”. The Second Half 106 features a first end with battery clamps 207 for connecting to a separate vehicle's battery terminals (likewise color-coded red and black). The second end terminates in a male electrical outlet connector 203, such as a standard three-prong male plug. This component is marked with a blue tag labeled “GA BAT”. When a lower amp cable is used, the system may be configured limit current to 20-40 amps, for example, with a circuit breaker or fuse 201 that triggers when the operator attempts to crank with the lower amp rated extension, e.g., 20 amp extension cord.

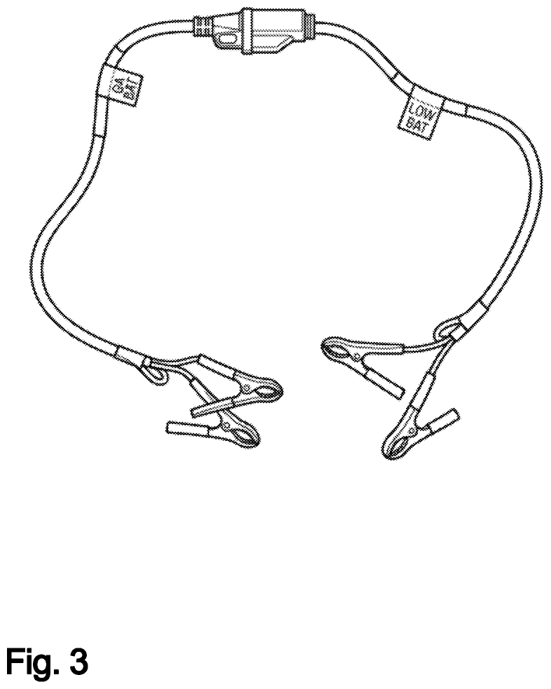

Referring now to FIG. 3, the direct connection between the first and second cable halves is illustrated when an extension cord is not utilized. The male electrical outlet connector of the “Second Half” is shown plugged directly into the female electrical outlet connector of the “First Half”. This configuration, as depicted in FIG. 3, allows the two halves to be joined either to each other for a short-range connection or to the respective ends of an extension cord for extended reach. Thus, creating a compact, short jumper cable suitable for vehicles parked close together. The blue labeling tags (“GA BAT” and “LOW BAT”) are visible on the respective cable segments, ensuring the user can identify the appropriate side for the donor battery and the discharged battery

The essence of the invention lies in the ability to connect the First Half and Second Half via any standard electrical extension cord (as shown in FIG. 1), thereby transforming two short battery clamp cables into a single, extended automotive jumper cable. This modularity enables users to easily create long, customizable jumper cables using commonly available extension cords, significantly improving reach and convenience, especially in emergency roadside or off-grid scenarios.

The cable segments are preferably constructed of high-current-rated, flexible orange insulated wire (to visually match common high-visibility extension cords) with appropriate gauge (e.g., 4-8 AWG) for safe 12V DC automotive jump-starting currents. Polarity is maintained throughout by the color-coded clamps and consistent wiring orientation in both halves.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A modular jumper cable apparatus, comprising:
a first cable segment having a first end provided with a first pair of battery clamps configured for connection to a discharged vehicle battery and a second end terminating in a female electrical outlet connector; and
a second cable segment having a first end provided with a second pair of battery clamps configured for connection to a donor vehicle battery and a second end terminating in a male electrical plug connector, wherein the male electrical plug connector of the second cable segment is configured to (i) directly mate with the female electrical outlet connector of the first cable segment to form a short-range jumper cable, and (ii) alternatively mate with female receptacle end of a standard electrical extension cord while a male plug end of the same extension cord mates with the female electrical outlet connector of the first cable segment, thereby forming an extended-length jumper cable of user-selectable length.

2. The modular jumper cable apparatus of claim 1, wherein the female electrical outlet connector and the male electrical plug connector are standard three-prong household electrical connectors.

3. The modular jumper cable apparatus of claim 1, wherein the female first cable segment further comprises a visible identification tag labeled “LOW BAT” affixed proximate the female electrical outlet connector, and the second cable segment further comprises a visible identification tag labeled “GA BAT” affixed the male electrical plug connector.

4. The modular jumper cable apparatus of claim 1, wherein the first pair of battery clamps and the second pair of battery clamps are color-coded with red insulation on the positive conductor and black insulation on the negative conductor.

5. The modular jumper cable apparatus of claim 1, wherein the first and second cable segments comprise high-visibility orange insulated wire having a gauge sufficient to carry automotive jump-start currents.

6. The modular of jumper cable apparatus of claim 1, wherein the apparatus is configured such that, when connected directly or via an extension cord, the red and black polarity of the battery clamps is preserved end-to-end.

7. The modular jumper cable apparatus of claim 1, further comprising at least one standard electrical extension cord packaged together with the first and second cable segments as a kit.
